(19) United States
(12) Patent Application Publication
(10) Pub. No.: US 2007/0023968 A1
(43) Pub. Date: Feb. 1, 2007

(54) Method for the production of a hydraulic binding agent a structural component use thereof and device therefor

(76) Inventors: Christoph Muther, Hergiswil (CH); Eduard Buzetszki, Wulkaprodersdorf (AT); Eckehard Maruhn, Liestal (CH)

Correspondence Address: BACHMAN & LAPOINTE, P.C., 900 CHAPEL STREET, SUITE 1201, NEW HAVEN, CT, 06510, US

(21) Appl. No.: 10/571,306

(22) PCT Filed: Sep. 7, 2004
(86) PCT No.: PCT/EP04/09953

§ 371 Date: Mar. 8, 2006

(30) Foreign Application Priority Data
Sep. 8, 2003 (AT) GM 609/2003

(51) Int. Cl. B28B 3/00

(52) U.S. Cl. 264/333

(57) ABSTRACT

Latent hydraulic materials are activated as residue from thermal processes by mechanochemical and/or tribomechanical reactions in a method for the production of an organic based binding agent. The lattice structures of the material mixture are altered by means of kinetic impingement, and the interaction of pulse and pulse interruption associated therewith, resulting in plasmoid particle states, the particle structure is altered by shock waves and/or by pent-up energy induced by the pulse and/or the pulse interruption. The particles are altered to form amorphous structured by the occurring pulses and pulse interruptions or reflections. The alterations occur by means of a device comprising an activator provided with a stator and a rotor arranged on a machine platform. The stator and the rotor define an annular chamber or annular gap as a transportation path for the material. Tools are associated with the annular gap of the stator and/or the rotor and are at least partially covered by a layer of the mixture. A dosing device and at least one air flow applied to other ring opening are arranged in front of the annular gap.

### BACKGROUND OF THE INVENTION

The invention relates to a method for the production of an inorganic-based hydraulic binding agent according to the present invention and to a structural component and an aerated concrete block. The invention furthermore encompasses a device for carrying out the method and the use of the binding agent on the one hand and of polyelectrolytes on the other hand.

Concrete is one of the most important building materials and usually consists of a mixture of mineral components—such as sand, gravel or rubble—and cement as binding agent; the latter sets when water is added and produces a type of conglomerate stone.

The most important hydraulic binding agent for concrete is Portland cement (PC), which consists of a finely ground mixture of PC clinker and calcium sulphates—such as gypsum or anhydrite. After mixing with water, it sets both in air and under water and retains its strength even under water. For its production, lime- and clay-containing raw materials—such as limestone, clay, lime marl and clay marl—are mixed with one another in such a way that the mixture of raw materials contains between 75 and 79% by weight of lime (CaCO₃) in addition to silicic acid (SiO₂), alumina (Al₂O₃) and iron oxide (Fe₂O₃) from the clay part. Preferably, there are at least 1.7 parts by weight of lime per part by weight of soluble silicic acid, alumina and iron oxide. The mixture is finely ground and then usually heated in rotary furnaces with an upstream preheating system of different type until sintering is achieved. The Portland cement clinker resulting from this process is then finely ground and processed by adding aggregates such as gypsum or the like to form Portland cement.

Other types of cement include, for example, slag cements (iron Portland cement and blast furnace slag cement), trass cement and oil shale cement, which contain various aggregates other than the Portland cement clinker (DIN 1164). Special cements which are not standardized as cement include, inter alia, aluminous cement, deep well cement and expanding cement.

Cements are sold in three quality classes. The high-quality cements CEM 42.5 and CEM 52.5 differ from the standard cement CEM 32.5 by a different composition and a finer grain size, which gives rise to faster setting—not binding—and on standardized test bodies after 28 days results in the compressive strengths denoted by the numbers. The higher initial strengths of the high-quality cements allow earlier removal of the formwork and thus faster progress of the construction work.

In order to reduce the costs for the production of binding agents, alternatives to the starting materials used are increasingly being sought. For example, fly ash is used as an aggregate in concrete production; fly ash is a product which is removed by filter systems from the waste gas of industrial furnaces or waste incineration plants, which is carried along as combustion residue in the combustion gases and mechanically removed or condensed out of the vapour state upon cooling.

Also used are calcined ashes and fly ashes (for example from industrial furnaces from the paper industry) or slag sands. The latter are formed when the burning blast furnace slag flowing from the slag hole of the blast furnace is introduced into moving water.

These aforementioned aggregates which are used in cement mean that the binding agent cures more slowly. For example, a strength achieved after 28 days in the case of conventional concrete will be achieved only after approximately 90 days. These so-called latent hydraulic binding agents can therefore be used only to a very limited extent.

### SUMMARY OF THE INVENTION

In view of these conditions, the object of the invention is to improve the usability of latent hydraulic binding agents—particularly those based on fly ash, calcined ash or slag sand and combusted oil shale—for practical use in the construction sector, and in particular to permit faster setting.

The teaching of the present invention aims to achieve this object; the present invention provides advantageous further developments. Moreover, all combinations of at least two of the features disclosed in the description, the drawing and/or the present invention falls within the scope of the invention. In respect of stated numerical ranges, values which lie within the stated limits are also intended to be disclosed as limit values and can be used at will.

By means of suitable components which can be used to balance out different fly ash compositions, on the one hand and a treatment of the mixture in an activator on the other hand, the materials in the latent hydraulic state can be altered in terms of the lattice structure and the geometry of the individual particles, in such a way that active hydraulic effects are obtained which then correspond to a high-quality Portland cement clinker.

By subjecting the mixture to high mechanical stress in an activator, the product is ground and this results inter alia in an increase in the surface area. Moreover, the globular structures of a fly ash are altered in such a way that an amorphous structure is obtained. This structure promotes the binding process by hooking the individual particles together and increases the strength values, in particular the compressive strength and the bending tensile strength.

The newly created reactive surfaces of the mixture consequently increase the total specific surface area of the particles or grains—also referred to as the Blain value. The increase in surface area as a result of the fine grinding operation on the one hand and the conversion of the particle structures into reactive surfaces on the other hand result in an overall increase in the Blain value by 8 to 24 times that of a Portland cement.

The collision of the particles onto and against one another and the reflections which occur on the tools give rise to shock waves in the particles which lead to splitting of the particles into amorphous structures and to disruptions to the lattice structure within the particles.

During the impact of the particles—or by the collision of the particles with one another on the one hand and the tools on the other hand—shock waves in interaction with occurring pent-up energy as a result of the pulse interruption propagate in the ultrasound range.

This energy—such as friction, kinetics and shear force acting on the particles—is largely converted into thermal energy which in turn is conducted away via the newly created surfaces and given off to the process air. The increase in temperature of up to more than 3000° C. which occurs repeatedly at the break points for a brief time within a few milliseconds causes a thermoplastic alteration of the interfaces. The particles involved are briefly in a plasmoid state.

The described mechanochemical and tribomechanical reactions activate the latent hydraulic mineral components. The mixture can then be used as a substitute for a Portland cement.

Tests have shown that this novel hydraulic binding agent—in addition to the conventional uses in structural engineering and civil engineering—can also be used in the production of porous concrete and refractory applications on account of its excellent properties.

An activator is used as the device for the production of this hydraulic binding agent. This device makes it possible, at high speeds of the rotating tools of up to 250 m/sec, to achieve the parameters required for activation. Control of the material supply, the air supply, the process heat and the material discharge is of great importance here.

The configuration of the tools for the mechanochemical and also tribomechanical effects is of particular importance.

The activator consists essentially of a rotor and a stator, which are held by a machine platform. The axis is arranged vertically. The drive is obtained via an electric motor by means of a V-belt on the rotor shaft assigned to the rotor. The rotational speed of the rotor can be adjusted in a step-free manner via a frequency converter. The tools can be exchanged and adjusted.

The products to be activated are fed in from a silo from above by a dosing device by means of a cellular wheel sluice into the interior of the activator. In an annular chamber or gap left free by the rotor and stator the mixture is conveyed downwards in a spiral, wherein the residence time of the product in this annular chamber can be adjusted by means of air flowing in the opposite direction. Moreover, this flow of air makes it possible to dissipate excess heat. In this annular chamber, the individual particles are thrown outwards against the stator by a pulse—caused by the rotor tools.

The tools both of the rotor and of the stator are permanently covered with a layer of the mixture so that the particles collide with one another and primarily with this layer. This mutual collision and the effects achieved thereby—such as plastic deformation, restoring behaviour, splitting, friction—give rise to a fundamental alteration of the physical characteristics of the particles.

Since layers of the mixture covering the tools are supported by the bearing and resistance force of the same, the mass of the tools substantially assists both the pulse and the pulse interruption and the interactions resulting therefrom, such as reflections between the tools.

The activatable mixtures, in terms of their chemical composition, are of similar orders of magnitude to that of the cements. However, the product produced is based mainly on silicic acid-containing fly ash, slag sand and slag from waste incineration.

This main constituent is in each case passed into the activator under oxidative conditions with the addition of aggregates—such as calcium oxides, calcium hydroxides, calcium carbonates and aluminium hydroxide for example. The supply of oxygen is ensured by air fed into the activator from below.

The required added amounts for a setting time comparable to that of conventional concrete lie in the range from 0.2 to 30 percent by weight in the case of calcium aluminate. The added amounts in the case of sodium aluminate or potassium aluminate are in each case 0.1 to 20 percent by weight. The specified percents by weight relate here to the finished binding agent mixture.

of course, it is also possible to use mixtures of calcium aluminate, sodium aluminate or potassium aluminate, in which the amount of the respective added components is defined such that the abovementioned ranges of the added components are not exceeded.

Typical formulas will now be discussed:

TABLE 1

| | Fly ash/ | | Burnt oil | |
|---|---|---|---|---|
| | Steink. % | Slag sand % | shale % | Ca alum. % |
| | by weight | by weight | by weight | by weight |
| Type A | 69 | 15 | 15 | 1 |
| Type B | 65 | 10 | 20 | 5 |
| Type C | 65 | 13 | 15 | 7 |

Types A to C are explained below:
Type A: (a) Characteristics
binds slowly in the form of strength class 32.5 N (>32.5 N/mm² standard strength after 28 days);
compressive strength after 7 days >16 N/mm²;
modulus of elasticity is defined with the strength class;
high bending tensile strength.

(b) Use
Finished products various concrete components (bricks, panels, angle plates or the like).
   Type B: (a) Characteristics
binds fairly quickly in the form of strength class 32.5 R (>32.5 N/mm² standard strength after 28 days);
compressive strength after 2 days >10 N/mm².

(b) Use
As type A and in civil engineering (foundation of borders, foundation of lampposts, substructure formwork or the like).
   Type C: (a) Characteristics
binds rapidly in the form of strength class 42.5 R (>42.5 N/mm² standard strength after 28 days);
compressive strength after 2 days >20 N/mm².

(b) Use
Civil engineering, structural engineering components and water engineering since it binds rapidly!

If further additives are added, these binding agents can be used in different sectors. The addition of cationic surfactants means that the component produced is water-resistant approximately 28 days after the setting phase; no more water is absorbed through the structure of the component.

The use possibilities are to be seen inter alia in the sectors of water engineering, waste engineering, sanitation and the clearing of polluted areas, etc.

By adding refractory components and increasing the amount of calcium aluminate to approximately 40%, this binder can be used in the sector of thermally stable building materials, such as in the linings of furnaces, converters, etc.

Also of particular interest is the use of the binder in the production of porous concrete. It has been found here that, when aluminium powder (less than 70 micrometres) is added, a closed-pore structure is obtained which corresponds to conventional products in terms of strength values, densities, etc.

However, the main advantage is the fact that there is no longer any need to use an autoclave, which is necessary in conventional production methods.

Open moulding and the waterproof nature and leaktightness that can be achieved when cationic surfactants are added are further advantages that are obtained in combination with the binding agent according to the invention.

The invention also encompasses a method for the production of building components such as bricks, panels or moulded parts for structural engineering and civil engineering, which can be implemented in a cost-effective manner; the building components thus produced have proven to be resistant to tensile and compressive stress and to weathering.

In order to achieve this, according to the invention a mixture of in each case equal amounts of clay with particle sizes of less than 100 μm, fine sand with particle sizes of 100 μm to 2 mm and sand with particle sizes of more than 2 mm is mixed in a mixer with polyelectrolytes—preferably polymers or copolymers based on acrylamide—and a hydraulic binding agent, placed in moulds and moulded at a pressure of at least 40 N/mm². This method can be carried out in a particularly simple manner since on the one hand only small demands are placed on the apparatus and on the other hand the required added components can be obtained easily and inexpensively. Here, clay is understood to mean that part of the soil with particle sizes of less than 100 μm, fine sand is understood to mean that part with particle sizes of 100 μm to 2 mm and sand is understood to mean that part with particle sizes above 2 mm. These clay, fine sand and sand components are widely available from soil, even though the amounts of clay, fine sand and sand obtained from the soil may differ in terms of their quantities from the required composition. European soils for example have a high content of loam and gravel, so that in this case quantities of sand have to be added. The required hydraulic binding agents, for example cement, highly hydraulic lime, lime hydrate or fine lime, are also widely and inexpensively available.

The mixture of clay, fine sand and sand which is required to carry out this method can be obtained in a simple manner since most soils contain these three constituents in sufficient quantity. In practical use, only the top layers of soil have to be removed in order to obtain the mixture of clay, fine sand and sand and, after removing gravel, stone and organic constituents, this is fed to mixing systems in which it is mixed with the respective binding agent and the polyelectrolytes. Only the composition of clay, fine sand and sand must be checked to ensure that these are present in equal amounts. A component may optionally be added if it is present in too small a quantity. If clay, fine sand and sand are present in essentially equal quantities, as defined above, this mixture, which is hereinafter also referred to as the “prepared mixture” can be passed to the further method steps.

The choice of respective binding agent and the required quantity to be added in each case depends in particular on the precise particle size distribution and the moisture content of the prepared mixture. In terms of the particle size distribution of the prepared mixture, it is not only the quantity distribution between clay, fine sand and sand that is of interest, but also the particle size distribution within each of these groups. Basic properties of the prepared mixture, for example in terms of its ability to be compacted, can already be derived therefrom.

As discussed in more detail below, usually fine lime or lime hydrate prove to be suitable as hydraulic binding agent for carrying out the method according to the invention, wherein in some cases it is also possible to use highly hydraulic lime, cement and bituminous binding agents.

The polyelectrolyte here in the conventional sense is a water-soluble ionic polymer which results anionically from polyacids—for example polycarboxylic acids—cationically from polybases—e.g. polyvinyl ammonium chloride—or is neutral (polyampholytes or polysalts). One example of natural polyelectrolytes are polysaccharides with ionic groups such as carrageen, but also proteins and long-chain polyphosphates. According to the invention, polyacrylamides are preferably used as polyelectrolytes, that is to say compounds consisting of monomers based on acrylamide. It is furthermore conceivable also to use mixtures of monomeric and polymeric polyelectrolytes, optionally together with solubilizers, emulsifiers and catalysts and with added amounts of propylene diamine, dimethyl ammonium chloride or isopropyl alcohol. Alternatively, mixtures of cationic surfactants can also be incorporated. These polyelectrolytes give rise to an agglomeration of the fine-grained constituents which is not based on the chemical conversion of water.

The blend consisting of clay, fine sand and sand mixture, polyelectrolyte and hydraulic binding agent is then placed in moulds and moulded at a pressure of at least 40 N/mm². The choice of pressure influences the ultimate strength of the building component, but it is usually possible to work with a pressure of 40-120 N/mm².

According to a further feature of the invention, the polyelectrolyte is added in a preferred amount of 0.001 to 2% by weight with respect to the dry weight of the mixture consisting of clay, fine sand and sand. Moreover, before adding the hydraulic binding agent, a styrene acrylic copolymer is added to the hydraulic binding agent, which is particularly advantageous in the case of wet and salty mixtures.

The objects of the invention are also achieved by the characterizing features of the present invention. This procedure is particularly advantageous in the case of prepared mixtures which have a low moisture content and a high content of fine sand. It is provided here that a bitumen emulsion and polyelectrolytes, preferably polymers or copolymers based on acrylamide, are added to the prepared mixture.

It has also proven to be advantageous to add the polyelectrolyte in a preferred amount of 0.001 to 2% by weight with respect to the dry weight of the mixture consisting of clay, fine sand and sand. To this end, the present invention finally covers the use of polyelectrolytes, preferably polymers or copolymers based on acrylamide, for the production of building components such as bricks, panels or moulded parts for structural engineering and civil engineering.

The present invention discloses bricks and moulded parts for structural engineering and civil engineering, which contain polyelectrolytes, preferably polymers or copolymers based on acrylamide.

This method according to the invention will be described in more detail below:

Firstly, in order to obtain the mixture of clay, fine sand and said, the top layers of soil are removed and, after removing gravel, stone and organic constituents, fed to mixing systems. No high demands are placed on the composition of these layers of soil, since the clay, fine sand and sand components required to carry out the method are usually present in sufficient quantity. Only the relative composition of clay, fine sand and sand must be checked to ensure that these are present in each case in equal amounts for further processing. Where necessary, a component must be added if it is present in too small a quantity.

Once clay, fine sand and sand components are present essentially in equal amounts, as defined above, this prepared mixture is mixed with polyelectrolyte in a mixer in a subsequent method step. As already mentioned, polyelectrolytes here means water-soluble ionic polymers which result anionically from polyacids—for example polycarboxylic acids—cationically from polybases—e.g. polyvinyl ammonium chloride—or are neutral (polyampholytes or polysalts). It is furthermore conceivable also to use mixtures of monomeric and polymeric polyelectrolytes, optionally together with solubilizers, emulsifiers and catalysts and with added amounts of propylene diamine, dimethyl ammonium chloride or isopropyl alcohol. These polymers have ionic dissociable groups which may form part of the polymer chain and the number of which is so large that the polymers are water-soluble in dissociated form. Use is preferably made of polyacrylamide in suspension form. In aqueous solution, polyelectrolytes have reactive groups which exhibit high affinity for the surfaces of the colloids and extremely fine particles of the fine-grained part of the soil. Depending on the ionogenicity of the polyelectrolyte, the interactions with respect to the solids particles are based on the formation of hydrogen bridges, as is the case with non-ionic polymers, or on electrostatic interactions and on charge exchange and the resulting destabilization of the particle surface. The anionic (=negatively charged) and cationic (=positively charged) polyelectrolytes act in this way. The destabilization and linking of a large number of individual particles leads to irreversible agglomeration of the fine particles in the clay, fine sand and sand mixture, which gives rise to a higher density and thus a higher strength of the building component ultimately produced. The polyelectrolytes used according to the invention can thus also be referred to as surface-active substances.

An important factor for the optimal effect of the polyelectrolyte is represented by the potentials active at the particle surface. These depend both on the particles themselves and on the ambient conditions, that is to say on the ionic strength of the conglomeration and the properties defined thereby, such as pH value, electrical conductivity or hardness.

By means of relatively simple preliminary tests, the person skilled in the art will determine the polyelectrolyte with the appropriate ionogenicity that is suitable for the respective application. However, it has been found that polyacrylamide for example is suitable in most cases and exhibits good properties with respect to setting. The polyelectrolyte is in this case used in a preferred amount of 0.001 to 2% by weight with respect to the dry weight of the conglomeration. The amount will depend in particular on the ionogenicity of the polyelectrolyte used and on the fine-grained part of the mixture. When using polyacrylamide, usually 0.01% by weight has proven to be sufficient. In the case of clay, fine sand and sand mixtures with a low moisture content, any necessary addition of water can be added via dilution with water.

In a further method step, in the case of a wet and/or salty mixture and/or a mixture with a high content of fine grains, a styrene acrylic copolymer is added, for example an acrylic acid dispersion. In the case of a prepared mixture with a low moisture content and a high content of fine grains, a bitumen emulsion is preferably added. However, it is not ruled out that a mixture of a styrene acrylic copolymer and of a bitumen emulsion may also prove to be advantageous.

The hydraulic binding agent is then added. Usually, fine lime or lime hydrate prove to be suitable binding agents for carrying out the method according to the invention, wherein, in cases with a respectively high content of relatively large particle sizes, highly hydraulic lime, cement and bituminous binding agents may also prove to be advantageous. The added amount of the respective binding agent also depends in particular on the moisture content of the prepared mixture, wherein it is desired to achieve the so-called Proctor optimum at which the mixture reaches the degree of saturation at which the optimal compactability of the mixture is obtained. Soils and thus the clay, fine sand and sand components obtained therefrom often have too high a moisture content, with water being drawn from the mixture when use is made of fine lime, lime hydrate or highly hydraulic lime. This can be attributed on the one hand to the chemical conversion of calcium oxide (CaO) into calcium hydroxide (Ca(OH)₂) with binding of water, but on the other hand also to the thermal energy released during this reaction, which leads to the physical evaporation of water. The water content of the mixture should be at the Proctor optimum or slightly above for this method according to the invention.

The blend consisting of clay, fine sand and sand mixture, polyelectrolyte and hydraulic binding agent and any required additives such as styrene acrylic copolymers is then placed in moulds and moulded at a pressure of at least 40 N/mm². The choice of pressure influences the ultimate strength of the building component, wherein it is nevertheless usually possible to work with a pressure of 40 to 120 N/mm². After compression, the building components can be subjected to stress after 50% drying.

These methods according to the invention thus firstly give rise to an irreversible joining of the starting components, namely clay, fine sand and sand. This is achieved by agglomeration of the small-grained components and alteration of the capillary water conveyance by breaking up the adhering water film on the colloidal constituents. This results in better compressibility of the mixture and a high strength of the building component produced by means of the method according to the invention.

The scope of the invention also includes a method for the production of an aerated concrete block, in which a mixture of a hydraulic binding agent, a fine-grained component, water and an aerating agent is produced, cast in moulds and dried.

For the production of aerated concrete blocks, various methods are known in which use is made in each case of a mixture consisting of
a fine-grained component, such as quartz sand for example,
lime,
a hydraulic binding agent, such as cement for example,
water
and an aerating agent as pore former.

To this end, lime and cement are used in approximately equal parts, and the aerating agent used is usually aluminium powder. The amount of aerating agent is in this case less than 0.05% by weight of the overall mixture. The reaction of the calcium hydroxide with the aluminium releases hydrogen, which is responsible for the high number of pores. The mixture is cast in moulds, wherein it is also possible to cut different formats and profilings in the semi-solid state. The high strength of the porous concrete is achieved after approximately four to eight hours by steam-curing in autoclaves at approximately 160 to 220° C. and approximately 12 to 15 bar pressure. During this, the hydrogen escapes and the pores that are formed are filled with air. The effect of the pressure and the hot steam gives off silicic acid from the surface of the sand grains, which together with the binding agent lime (lime hydrate) forms crystalline binding agent phases—so-called CSH phases. These crystalline binding agents bind to the sand grains and create a solid structure of the individual additives. The aerated concrete blocks thus produced have relatively low densities of up to 400 kg/m³ and have good heat insulation properties on account of the pore structure and the air inclusions thereof.

However, on account of the machines and systems to be used, methods of this type are expensive and use a lot of power. For example, high pressures have to be maintained in the autoclave over a number of hours, wherein the high power consumption can be attributed primarily to the required heat treatment with steam. It is also disadvantageous that for example groove and springs must be milled into the blocks subsequently; complicated shapes are often not possible on account of the necessary steam curing. The quartz sands usually used to produce aerated concrete blocks must moreover be of high quality and may sometimes only be provided to the production works after relatively long transport. When aluminium is used in a production environment, there is also a risk of explosion.

In order to avoid these disadvantages and provide a relatively inexpensive method, in order to produce the hydraulic binding agent used for this method according to the invention, domestic waste is comminuted, homogenized and mixed with calcium-containing additives such as dolomite, calcite, lime marl or marl and with aluminium oxide-containing aggregates such as corundum abrasives, clay marl or clinker, and burnt; then up to 40% by weight of tectosilicates, for example tuff, are added and the resulting product is ground to an average particle size of less than 0.063 mm. Furthermore, the fine-grained component used is a fine slag from waste incineration plants or slag from smelting works or steelworks, and the aerating agent is a surface-active agent. These constituents will be explained in more detail below.

Typical domestic waste contains, in percent by weight, usually 59 to 69% silicon oxide, 4.9 to 7.8% iron oxide, 5.1 to 6.3% aluminium oxide and 8.3 to 10.3% lime, and is therefore suitable for the production of an inorganic binding agent for concrete-type setting compounds.

The production of the binding agent may take place in waste incineration plants operated by special fuel from waste. This gives, in % by weight, 18 to 26% silicon oxide, 2 to 5% iron oxide, 4 to 12% aluminium oxide and 58 to 66% lime and 2 to 5% magnesium oxide.

The combustion bed temperature is at least 950° C. and the calorific value of the waste is at least 13 MJ/kg. This ensures that practically no additional primary energy has to be used for combustion purposes.

The additives used may be calcium-containing waste from industry or calcium-containing stone, such as dolomite, calcite, lime marl and the like, which are easily available.

The aggregates used may likewise be industrial waste, such as corundum abrasives, but also clay marl, clinker and the like.

This generally gives an ignition loss of approximately 5%, a sulphate content of 4%, a chloride content of approximately 3%, a Blair value of 5000 cm²/g and a total base content of p>2, wherein the total base content is calculated via p=(CaO+MgO+Al₂O₃+Fe₂O₃)SiO₃.

By virtue of the ion exchange occurring during the process and by virtue of sorbtion, any harmful substances possibly contained in the domestic waste are bound and can therefore be leached out of the binding agent and the concrete produced therewith, and thus do not represent any appreciable risk to the environment. It is largely possible to omit the need for raw materials which can be obtained only with considerable outlay. At the same time, the problem concerning storage and treatment of houshold waste is substantially alleviated. Since the energy is essentially provided by the domestic waste itself, very consdierable energy savings are also made during production of the binding agent.

According to the invnetion, the fine-grained component used is fine slag from waste incineration plants or slag from smelting works or steelworks. This is the solid, non-combustible residues which arise during the course of incineration in industrial furnaces or waste incineration plants.

In waste incineration, slag amounts to approximately 35% of the original weight of the waste. Beside iron-containing components, waste incineration slag also contains significantly smaller amounts of non-ferrous metals such as copper, nickel, lead, zinc or tin in varying quantities.

Ironworks slag can be broken down into blast furnace slag and steelworks slag, wherein blast furnace slag arises during the production of crude iron in the blast furnace and steelworks slag arises during the production of steel in converters, in electric furnaces and in Siemens-Martin furnaces.

Metal smelting slag is formed during the production of non-ferrous metals. According to the current state of the art, approximately 250 kg of blast furnace slag is produced per ton of crude iron and approximately 120 kg of steelworks slag is produced per ton of crude steel. Large amounts of slag are thus produced, which can be reused.

Blast furnace slag and steelworks slag differ in terms of their chemical composition, but on account of their main constituents of calcium oxide, silicon dioxide, aluminium oxide and iron oxide they are both also suitable for use with the method according to the invention.

It has been found that, due to the chemical composition of the binding agent obtained from domestic waste and of the fine slag from waste incineration plants or industrial furnaces, there is no need to use aluminium powder. Instead, use can be made of a relatively inexpensive aerating agent, such as a surface-active agent for example. This is understood to mean compounds which become greatly enriched from their solution at interfaces (e.g. water/oil) and as a result lower the interfacial tension—the surface tension in the case of liquid/gaseous systems. Although even polar solvents such as alcohols, ethers, pyridines, alkyl formamides, etc. are surface-active, within the scope of the invention the surface-active substances used are preferably those compounds which have a lipophilic hydrocarbon radical and a hydrophilic functional group or possibly even a number of hydrophilic functional groups——COONa, —SO₃Na, —O—SO₃Na and the like; such substances are also referred to as surfactants or detergents.

These may be water-soluble sodium or potassium salts of saturated and unsaturated higher fatty acids (also referred to as lye soap), or water-soluble sodium or potassium salts of resin acids of colophonium (also referred to as colophonium soap), or water-soluble sodium or potassium salts of naphthenic acids—for example casein-based enriched alkyl naphthalene sulphonic acid. Moreover, the surface-active agent should be added in an amount of 0.03 to 0.001% by weight with respect to the mixture prior to drying.

By way of a non-limiting example of embodiment, it is possible to produce, stated in absolute amounts, a mixture consisting of 780 kg of the hydraulic binding agent according to the present invention, 290 kg of fine slag, 250 kg of water and 0.25 kg of the surface-active agent, which after air drying results in an aerated concrete block having a density of approximately 600 kg/m³.

The drying may also take place without steam curing and without creating high pressures; instead, air drying proves to be sufficient. The maturation process up to processability of the aerated concrete blocks is in this case approximately 3 to 7 days, with the final strength increasing as the drying time increases. Not only does this result in a high energy saving, but it also makes it possible to produce complicated shapes on account of there being no need for steam autoclaving. The risk of explosion associated with the use of aluminium powder is omitted.

It has furthermore been found that, during the inflation process, a lower expansion pressure is produced than in the case of conventional production methods. As a result, it is also possible to use less expensive materials as formwork material for the casting of moulded parts. The use of inexpensive raw materials such as domestic waste or fine slag from waste incineration plants or industrial furnaces ensures an additional cost reduction of the method according to the invention.

During practical testing of the aerated concrete blocks produced by means of this method according to the invention, it has also been found that less water is absorbed on account of the closed-cell structure of the aerated concrete blocks and no shrinkage occurs, but rather, on the contrary, there is a slight swelling. This counteracts the risk of crack formation in the impact area.

The density of the aerated concrete blocks produced according to the invention is between 650 and 1200 kg/cm³. The compressive strengths and the bending tensile strengths are dependent on the density, with the ratio between compressive strength and bending tensile strength being considerably greater than in the case of concrete, that is to say the bending tensile strength is relatively high with respect to the compressive strength. This ensures that heat-insulating panels produced from this material have excellent stability for example. However, by means of this method according to the invention, it is also possible to reinforce the resulting aerated concrete block with fibres, for example based on coconut or synthetic material, as a result of which the bending tensile strength can be further considerably increased. It has been found that in particular the use of fine slag instead of the conventionally used fine sand has advantageous effects on the strength of the aerated concrete block produced by means of the method according to the invention.

In order to achieve lower densities of down to 300 kg/m³, it is possible to use, in addition to the surface-active agent, also powdered aluminium, this being aluminium from recycling materials according to the present invention. In this case, too, it is possible to omit the energy-intensive and complicated steam autoclaving operation.

According to a further feature, the powdered aluminium is added in an amount of 0.05 to 0.001% by weight with respect to the mixture prior to drying. The amount of aluminium powder used will depend on the one hand on the amount of surface-active agent used and on the other hand on the desired properties, in particular the density, of the aerated concrete block ultimately produced. Additional amounts of aluminium powder ensure in principle that the pore structure after drying is coarser, as a result of which the density of the aerated concrete block is reduced. In particular, the average pore size is dependent on the average particle size of the aluminium powder used. It is thus obvious that, depending on the mixing ratio and particle sizes of the aluminium powder used and of the aerating agent, different properties of the final aerated concrete block can be obtained.

Particularly when using aluminium powder from recycling materials, it has proven to be advantageous to mix the powdered aluminium with an alcohol solution before adding it to the overall mixture. This is because aluminium tends to become covered with an oxide layer which makes the aluminium non-reactive. The coating with alcohol prevents oxidation of the surface of the aluminium powder, as a result of which the effect of the aluminium powder during the method according to the invention is optimized.

However, according to the invention, it is also conceivable that, instead of fine slag, the fine-grained component that is used is fly ash from waste incineration plants or slag from smelting works or steelworks. Of course, it is also possible to replace amounts of the above-described hydraulic binding agent with conventional cement or amounts of the fine slag with conventional fine sand, if this means that certain properties of the resulting aerated concrete block can be optimized. By way of non-limiting examples of embodiments, the following formulas can thus be mentioned for aerated concrete blocks having a density of 500 to 600 kg/cm³ and strengths of 25 to 40 kg/cm² (after drying for 28 days):
330 kg of hydraulic binding agent according to the present invention, 165 kg of fine sand, 230 kg of water and 0.5 kg of a mixture of the surface-active agent and aluminium powder;
330 kg of hydraulic binding agent according to the present invention, 165 kg of fly ash, 300 kg of water and 0.5 kg of a mixture of the surface-active agent and aluminium powder;
165 kg of hydraulic binding agent according to the present invention, 165 kg of cement, 165 kg of fly ash, 300 kg of water and 0.5 kg of a mixture of the surface-active agent and aluminium powder.

By virtue of precisely adapted formulas, it is thus possible to achieve different properties of the aerated concrete blocks produced by means of the method according to the invention. The usability even in the case of complicated shapes is also made much simpler by omitting the steam curing operation.

This invention thus provides an extremely inexpensive method for the production of an aerated concrete block which is highly suitable for use as a high-quality, heat-insulating light building material.

### BRIEF DESCRIPTION OF THE DRAWINGS

Other advantages, features and details of the invention emerge from the following description of preferred examples of embodiments and with reference to the schematic drawing, in which

FIG. 1 shows an oblique view of a product to be crushed;

FIG. 2 shows an oblique view of the crushed product;

FIG. 3 shows an oblique view of a device for treating the product;

FIG. 4 shows an enlarged partial cross section through the device;

FIG. 5 shows an enlarged detail from FIG. 4;

FIG. 6 shows the side view of a tool part.

### DETAILED DESCRIPTION

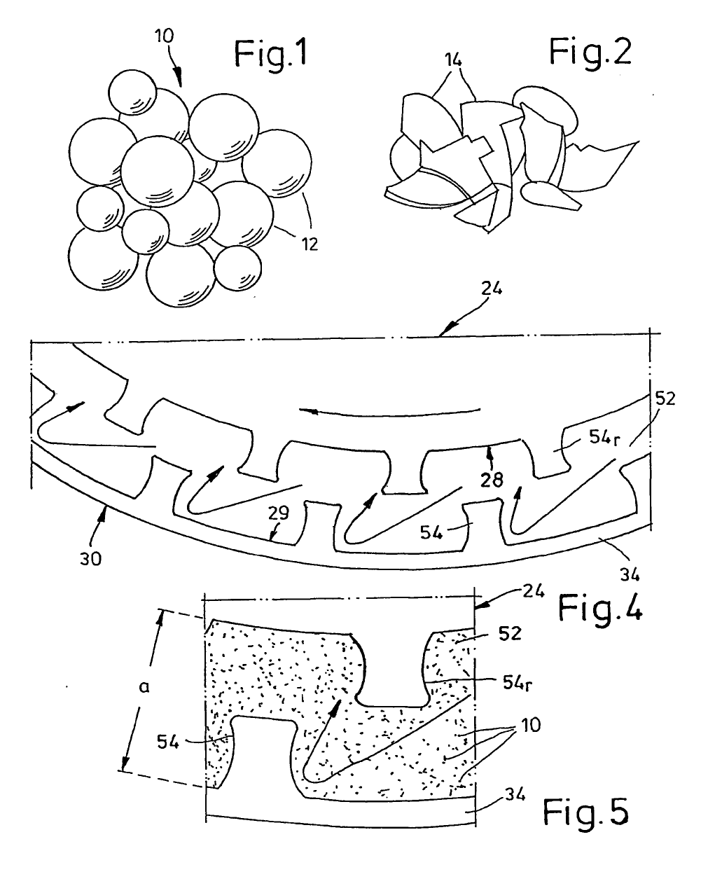

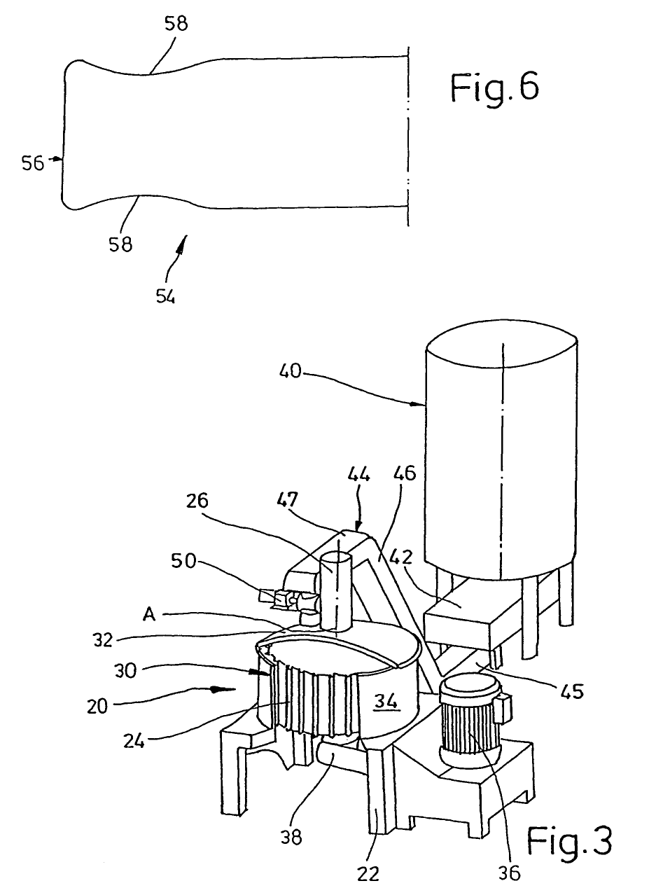

FIG. 1 shows a heap of debris 10 consisting of spherical constituents 12. By subjecting this mixture to high mechanical stress in an activator (described below), the product is crushed, as a result of which inter alia an increase in surface area is achieved. Moreover, the globular structures of a fly ash are altered such that an amorphous structure is produced. This structure promotes the binding process by hooking together the individual particles 14 formed by the comminution process, and increases the strength values, in particular the compressive strength and bending tensile strength.

As a result of the particles 12 colliding onto and against one another and the reflections occurring on the activator, shock waves propagate in the particles 12 and lead to splitting thereof into amorphous structures and to disruptions in the lattice structure within the particles, as shown in FIG. 2.

The comminution takes place in a so-called activator 20, which has a machine platform 22, a rotor 24 and a stator 30, the cover plate 32 of which is passed through by a rotor shaft 26. The latter runs coaxially with respect to the vertical axis A of the rotor 24.

The rotor 24 is driven via an electric motor 36 (visible outside the stator wall 34) by means of a V-belt 38 on the rotor shaft 26. The rotational speed of the rotor 24 can be adjusted in a step-free manner via a frequency converter (not shown).

Reference 40 denotes a cylindrical silo from which the debris 10 is fed to a dosing device 42. Running below the latter is a floor-level horizontal arm 45 of a conveyor 44 which is in this case Z-shaped when seen in longitudinal section; the inclined central section 46 of said conveyor merges into a front arm 47 above the cover plate 32 of the stator 30. Arranged downstream of said front arm is a cellular wheel sluice 50, through which the conveyed goods 10 are fed to the interior of the activator 20.

FIGS. 4, 5 illustrate an annular chamber 52 of radial width a between the outer face 28 of the rotor 24 and the inner face 29 of the stator 30. Tools 54 and 54ᵣ, respectively, protrude radially from both faces 28, 29. Said tools have a channel-like recess 58 on either side, close to their front end 56, as shown in FIG. 6.

In the annular chamber or annular gap 52, the mixture 10 is conveyed downwards in a spiral manner, wherein the residence time thereof can be adjusted by means of air flowing in the opposite direction. This stream of air also dissipates excess heat. In this annular chamber 52, the individual particles 14 are thrown outwards against the stator 30 by a pulse, which is caused by the rotor tools 54ᵣ.

The tools 54 and 54ᵣ both of the stator 20 and of the rotor 24 are permanently covered with a layer of the mixture 10 so that the particles collide with one another and primarily with this layer. This mutual collision and the effects achieved thereby—such as plastic deformation, restoring behaviour, splitting, friction—give rise to a fundamental alteration of the physical properties of the particles 14.

Since layers of the mixture covering the tools 54, 54ᵣ are supported by the bearing and resistance force of the same, the mass of the tools 54, 54ᵣ substantially assists both the pulse and the pulse interruption and the interactions resulting therefrom, such as reflections between the tools 54, 54ᵣ.

1-36. (canceled)

37. Method for the production of an inorganic-based hydraulic binding agent, wherein, in a material mixture, latent hydraulic materials are activated as residue from thermal processes by mechanochemical and/or tribomechanical reactions, characterized in that, by means of kinetic impingement of the material mixture, and the interaction of pulse and pulse interruption associated therewith, plasmoid states of the particles of the material mixture are brought about, wherein the particle structures are altered by shock waves produced by collision of the particles and/or by pent-up energy to form amorphous structures by the occurring pulses and pulse interruptions or reflections, and most of the pent-up energy acting on particles is converted into thermal energy, in that the hydraulic binding agent is produced from latent hydraulic components in an activator, and the materials to be activated are fed into an annular gap of the activator against the force of gravity and with air flowing in the opposite direction, and the thermal energy is conducted away via the resulting surfaces and given off to process air.

38. Method according to claim 37, wherein the shock waves in interaction with the pent-up energy propagate in the ultrasound range.

39. Method according to claim 37, wherein fly ash, burnt oil shale and slag sands are processed oxidatively with the addition of calcium oxides, calcium hydroxides, calcium carbonates and/or aluminium oxides or aluminium hydroxides under a supply of an oxygen-containing fluid.

40. Method according to claim 37, wherein the binding agent is obtained from residues of the fly ash resulting from the combustion of materials containing silicic acid, alumina, iron oxide and lime, said fly ash preferably being taken from bituminous coal, brown coal or anthracite coal power stations.

41. Method according to claim 37, the binding agent is obtained from residues of the calcined ash or fly ash resulting from the combustion of materials containing silicic acid, alumina, iron oxide and lime, said ash preferably being taken from industrial furnaces.

42. Method according to claim 37, wherein the binding agent is provided with slag sand or burnt oil shale resulting from the combustion of materials containing silicic acid, alumina, iron oxide and lime.

43. Method according to claim 39, wherein calcium aluminate in the range from 0.2 to 30% by weight as an added component.

44. Method according to claim 39, wherein sodium aluminate or potassium aluminate in the range from 0.1 to 20% by weight as an added component.

45. Method according to claim 37, wherein an aluminium powder is added to the binding agent to produce a porous concrete.

46. Method according to claim 37, characterized in that cationic surfactants are added to the binding agent and the latter is made to be water-tight and water-resistant.

47. Method according to claim 37, characterized in that the particles of the materials are thrown against a stator which defines the annular gap towards the outside, and a pulse is generated.

48. Method according to claim 37, characterized in that the particles of the materials are thrown against a layer of the mixture on tools of the activator, and a pulse is generated.

49. Method for the production of a building component such as a brick, a panel or a moulded part for structural engineering and civil engineering, wherein a mixture of in each case equal amounts of clay with particle sizes of less than 100 μm, fine sand with particle sizes of 100 μm to 2 mm and sand with particle sizes of more than 2 mm is mixed with polyelectrolytes, preferably polymers or copolymers based on acrylamide, and a hydraulic binding agent produced according to claim 37, placed in moulds and moulded at a pressure of at least 40 N/mm².

50. Method for the production of a building component such as a brick, a panel or a moulded part for structural engineering and civil engineering, wherein a mixture of in each case equal amounts of clay with particle sizes of less than 100 μm, fine sand with particle sizes of 100 μm to 2 mm and sand with particle sizes of more than 2 mm is mixed with polyelectrolytes, preferably polymers or copolymers based on acrylamide, and a bitumen emulsion with a hydraulic binding agent produced according to claim 37, placed in moulds and moulded at a pressure of at least 40 N/mm².

51. Method according to claim 49, wherein the polyelectrolyte is added in an amount of 0.001 to 2% by weight with respect to the dry weight of the mixture consisting of clay, fine sand and sand.

52. Method according to claim 49, wherein, prior to mixing with the hydraulic binding agent, a styrene acrylic copolymer is added to the hydraulic binding agent.

53. Method for the production of an aerated concrete block, in which a mixture consisting of a hydraulic binding agent, a fine-grained component, water and an aerating agent is produced, cast in moulds and dried, wherein, in order to produce the hydraulic binding agent according to claim 37, domestic waste is comminuted, homogenized and mixed with calcium-containing additives such as dolomite, calcite, lime marl or marl and with aluminium oxide-containing aggregates such as corundum abrasives, clay marl or clinker, and burnt, then mixed with up to 40% by weight of tectosilicates, for example tuff, and the resulting product is ground to an average particle size of less than 0.07 mm, preferably 0.063 mm, and the fine-grained component used is fine slag from waste incineration plants or slag from smelting works or steelworks, and the aerating agent is a surface-active agent.

54. Method according to claim 53, wherein the surface-active agent used is water-soluble sodium or potassium salts of saturated and unsaturated higher fatty acids or the resin acids of colophonium or naphthenic acids, preferably casein-based enriched alkyl naphthalene sulphonic acid.

55. Method according to claim 53, wherein the surface-active agent is added in an amount of 0.03 to 0.001% by weight with respect to the mixture prior to drying.

56. Method according to claim 53, wherein the additional aerating agent used is powdered aluminium from recycling materials.

57. Method according to claim 56, wherein the powdered aluminium is added in an amount of 0.05 to 0.001% by weight with respect to the mixture prior to drying, wherein the powdered aluminium is preferably mixed with an alcohol solution before being added.

58. Method according to claim 54, wherein the fine-grained component used is fly ash from waste incineration plants or slag from smelting works or steelworks.

59. Device for carrying out the method according to claim 37, wherein an activator (20) with a stator (30) and a rotor (24) on a machine platform (22), wherein the stator and the rotor define an annular chamber or annular gap (52) as a transportation path for the materials (10, 12), with a dosing device (42) arranged upstream of the annular gap (52) and also at least one counter-current air supply line fitted to the other end of the annular gap.

60. Device according to claim 59, wherein tools (54, 54ᵣ) of the stator (30) and/or rotor (24) which are assigned to the annular gap (52) and are at least partially covered by a layer of the mixture.

61. Use of a binding agent produced according to the method of claim 43 with an increased amount of calcium aluminates compared to the range of 0.2 to 30% by weight as added component and an addition of refractory components for the production of refractory linings and moulded parts.

62. Use of a binder produced according to the method of claim 37 and of polyelectrolytes, preferably polymers or copolymers based on acrylamide, for the production of building components such as bricks, panels or moulded parts for structural engineering and civil engineering.

63. Moulded part or brick produced for structural engineering and civil engineering using a binding agent produced according to the method of claim 37, wherein it contains polyelectrolytes, preferably polymers or copolymers based on acrylamide.
